(19) United States
(12) Patent Application Publication
(10) Pub. No.: US 2025/0311006 A1
(43) Pub. Date: Oct. 2, 2025

(54) DYNAMIC SELECTION OF RANDOM ACCESS CONFIGURATION

(71) Applicant: QUALCOMM Incorporated, San Diego, CA (US)

(72) Inventors: Nazmul ISLAM, Littleton, MA (US); Sambit BEHURA, Hyderabad (IN); Hemasagar MISHRA, Balangir (IN); Linhai HE, San Diego, CA (US)

(21) Appl. No.: 18/618,607

(22) Filed: Mar. 27, 2024

(51) Int. Cl. H04W 74/0833; H04W 74/00; H04W 74/08

(52) U.S. Cl. CPC H04W 74/0833; H04W 74/006; H04W 74/0866

(57) ABSTRACT

Certain aspects of the present disclosure provide techniques for dynamic selection of a random access configuration. An example method for wireless communications by an apparatus includes obtaining a plurality of configurations for random access communications; and obtaining signaling that indicates to start a random access procedure, wherein the signaling includes a first field including an indicator of a first configuration of the plurality of configurations.

### INTRODUCTION

### Field of the Disclosure

Aspects of the present disclosure relate to wireless communications, and more particularly, to techniques for random access communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining a plurality of configurations for random access communications; and obtaining signaling that indicates to start a random access procedure, wherein the signaling includes a first field including an indicator of a first configuration of the plurality of configurations.

Another aspect provides a method for wireless communications by an apparatus. The method includes sending a plurality of configurations for random access communications; and sending signaling that indicates to start a random access procedure, wherein the signaling includes a first field including an indicator of a first configuration of the plurality of configurations.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6 depicts an example architecture for dynamic selection of random access configuration.

FIG. 7 depicts a process flow for signaling of a dynamic selection of a random access configuration.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for dynamic selection of a random access configuration.

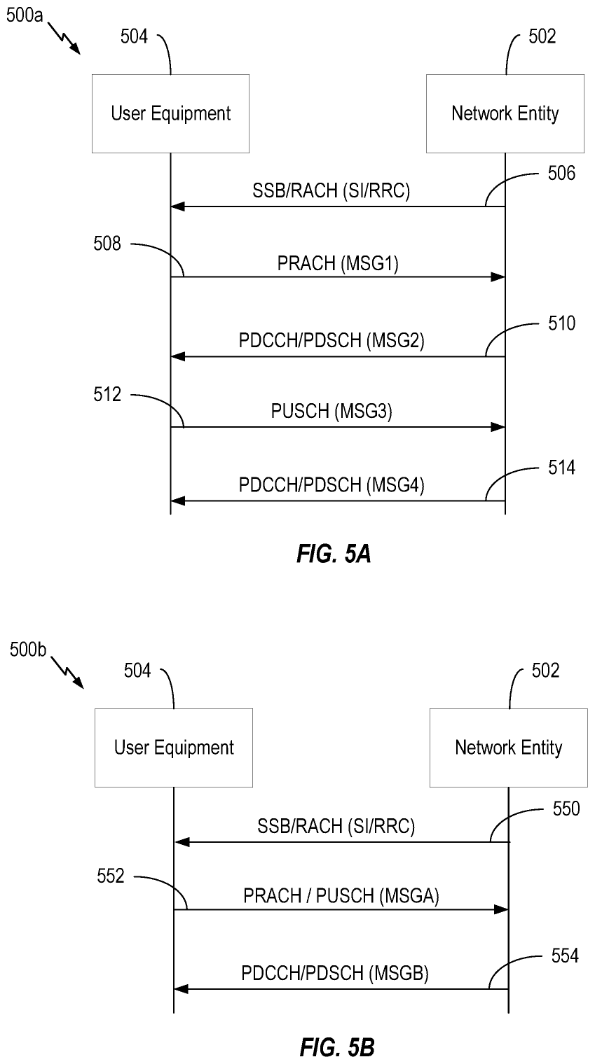

In certain wireless communication systems (e.g., 5G New Radio systems and/or any future wireless communications system), a user equipment (UE) may communicate with a network entity (e.g., a base station) using a random access procedure, for example, for initial access to the network entity, for beam failure recovery, to obtain timing information (e.g., a timing advance), to request uplink communication resources, to request system information, etc. An example random access procedure may begin with the UE sending a random access preamble on a physical random access channel (PRACH) in a random access occasion (RO), which may include one or more time-frequency resources. Upon successful reception of the preamble, the network entity sends, to the UE, a response to the preamble in a random access response (RAR) window. The response may include an uplink scheduling grant. On receiving the response, the UE may send a request to setup a connection with the network entity, and then, the network entity may reply with a contention resolution response. Certain aspects associated with random access communications are further described herein, for example, with respect to FIGS. 5A and 5B.

Technical problems for random access communications may include, for example, effective usage of certain resources (e.g., preambles, the total number of ROs, and/or time-frequency resources for ROs, etc.) for random access communications. In certain cases, a UE obtains, from a network entity, one or more configurations for random access communications. A configuration may identify certain parameters for random access communications, such as a set of preambles, a time-frequency resource set for the ROs, a periodicity for the ROs, and/or a duration for the RAR window. The configurations may include a common configuration and a set of feature-specific configurations for random access communications. A feature-specific configuration may be designated for a specific combination of one or more features associated with a UE, such as a reduced capability UE (e.g., a type of Internet of Things IoT device), a small data transmission (SDT) UE (e.g., another type of IoT device), random access message repetition (e.g., preamble repetitions for coverage enhancements), etc. For example, a network entity may designate a first set of RACH resources for SDT UEs via a feature-specific configuration and a second set of RACH resources for other UE(s) via the common configuration. In some cases, the first set of RACH resources may go unused or underused for random access communications, for example, due to sparse or no SDT traffic. In certain cases, the second set of RACH resources may go unused or underused for random access communications, for example, due to sparse or no traffic via other UE(s). Accordingly, there may be a non-trivial amount of RACH resources that are underutilized for random access communications.

Aspects described herein overcome the aforementioned technical problem(s) by providing dynamic selection of a random access configuration. More specifically, the dynamic selection of a random access configuration may be conveyed via signaling that triggers a random access procedure, such as a physical downlink control channel (PDCCH) order for a random access procedure via downlink control information (DCI). The signaling may include one or more fields that identify a particular configuration to use for random access communications. For example, the signaling may indicate for a UE to use a particular feature-specific configuration regardless of whether the UE supports any of the feature(s) associated with the feature-specific configuration.

Certain techniques for dynamic selection of a random access configuration as described herein may provide various beneficial technical effects and/or advantages. The techniques for dynamic selection of a random access configuration may enable efficient random access channel usage, especially, for load balancing. The dynamic selection of a random access configuration may enable a network entity to direct random access traffic to resources assigned to a particular configuration, for example, for load balancing among random access resources. The dynamic selection of a random access configuration may allow a network entity to notify a UE to use a particular configuration for random access communications, for example, when a low level of usage is present for the resources assigned to that configuration.

In certain aspects, the dynamic selection of a random access configuration may enable a network entity to direct random access traffic to resources assigned to a particular configuration in order to satisfy certain performance specifications. For example, when a UE is communicating traffic with certain performance specifications (e.g., an expected latency and/or reliability), the network entity may direct random access traffic to resources assigned to a configuration that can satisfy the performance specifications. Accordingly, the dynamic selection of a random access configuration may enable improved performance of random access communications in terms of latency and/or reliability.

In certain aspects, the dynamic selection of a random access configuration may enable a network entity to direct random access traffic based on radio conditions, for example, to mitigate or avoid interference. For example, when a first set of RACH resources are encountering frequency dependent signal propagation effects (e.g., scattering, fading, or interference), and a second set of RACH resources are exhibiting better channel conditions than the first set of RACH resources, the network entity may direct random access traffic to the second set of RACH resources. Accordingly, the dynamic selection of a random access configuration may enable improved performance of random access communications, for example, via RACH resources with better channel conditions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

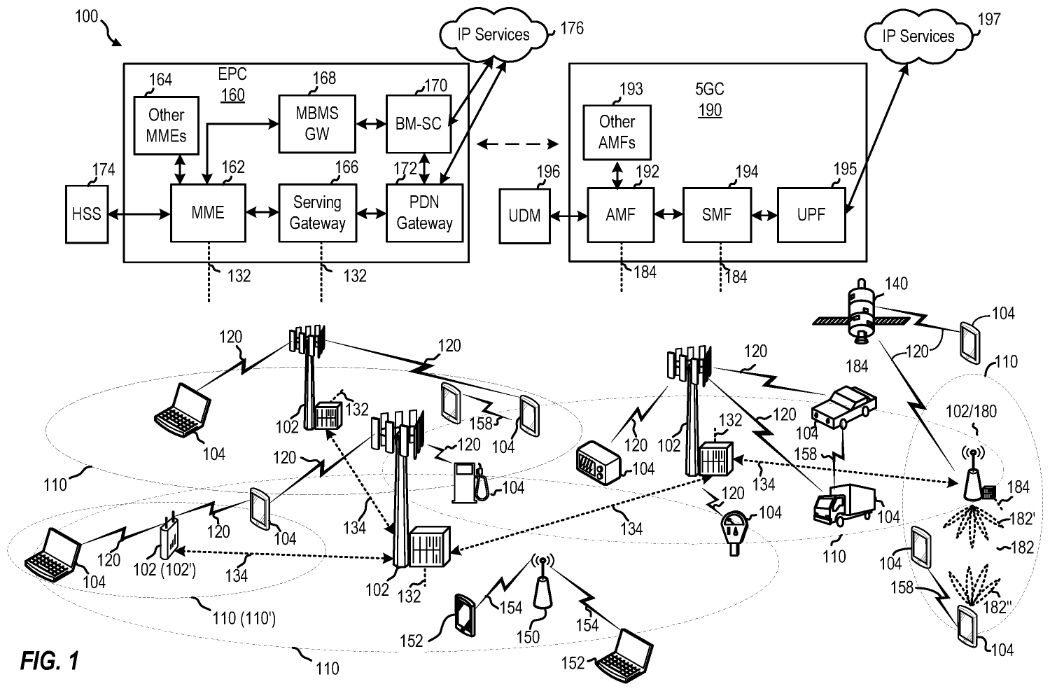

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

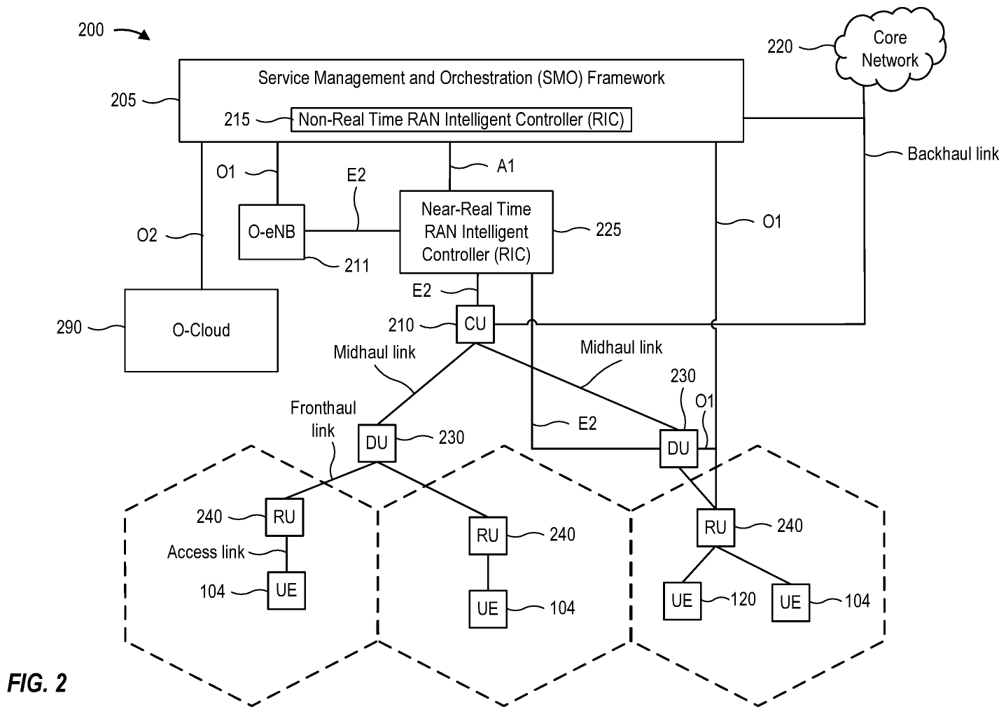

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

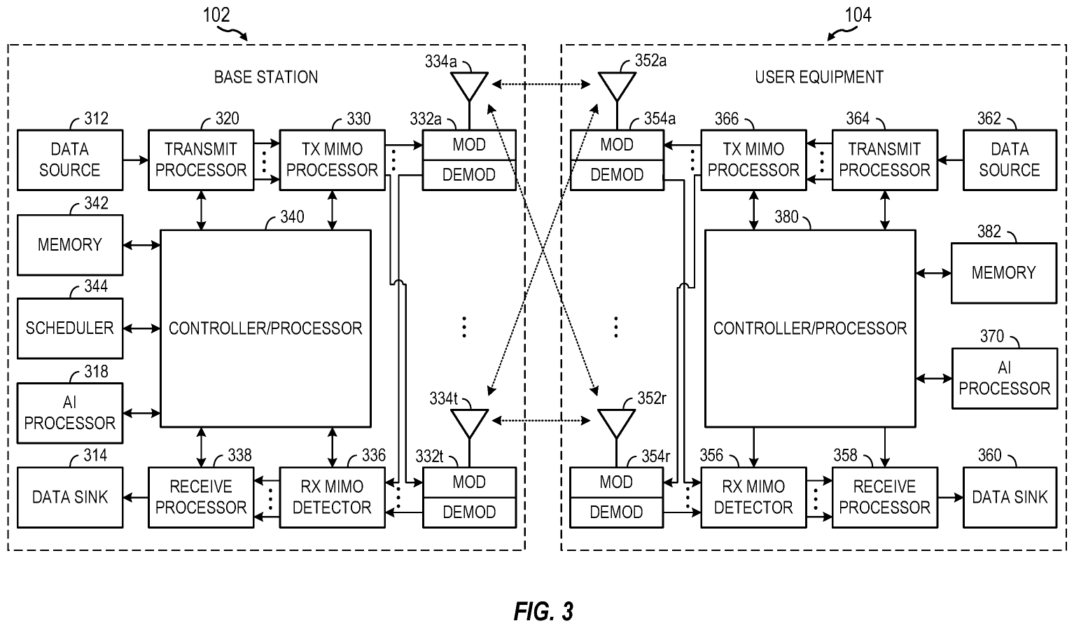

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

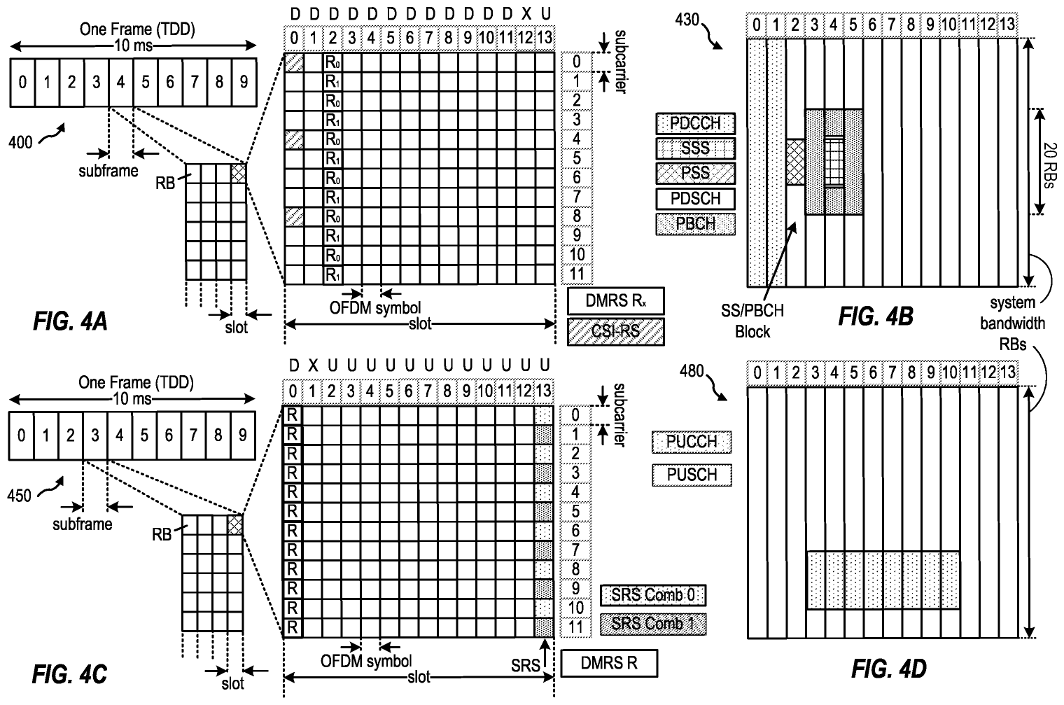

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any future wireless communications system) may provide a specified channel for random access, such as a random access channel (RACH), and corresponding random access procedure(s). As discussed above, random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

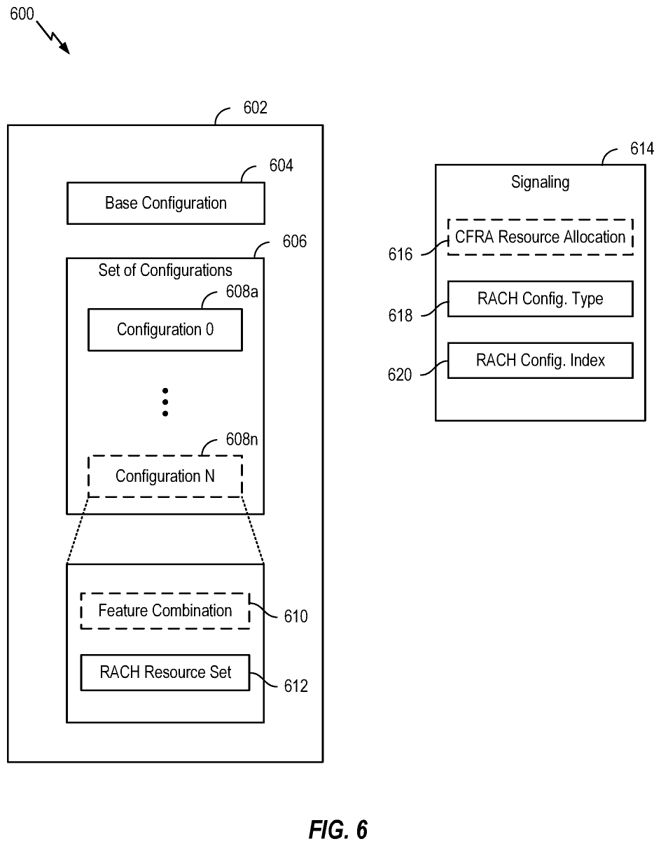

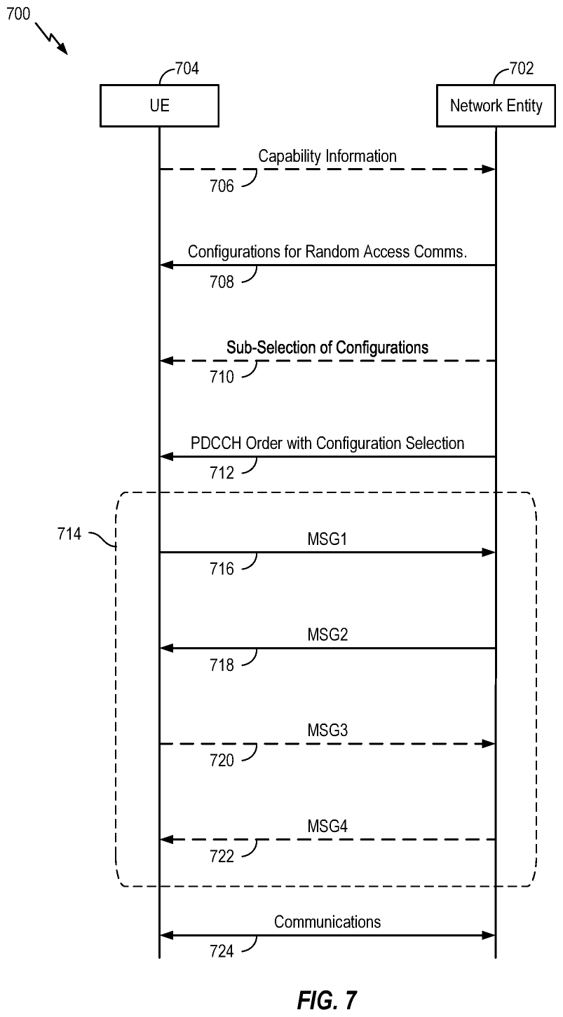

The RACH procedure 500a may optionally begin at 506, where the network entity 502 broadcasts and the UE 504 receives a random access configuration, for example, in system information (SI) within a synchronization signal block (SSB), or within an RRC message. The random access configuration may indicate or include one or more parameters for random access communications, such as defining the RACH, the total number of random access preambles (e.g., preamble sequences) available for random access, power ramping parameters, response window size (duration), etc. In certain aspects, the UE 504 may obtain a plurality of random access configurations, for example, as further described herein with respect to FIGS. 6 and 7.

At 508, the UE 504 sends a first message (MSG1) to the network entity 502 on a physical random access channel (PRACH). In some cases, a PRACH may be referred to as a RACH. In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

### Aspects Related to Dynamic Selection of Random Access Configuration

Aspects of the present disclosure provide dynamic selection of a random access configuration. In particular, the dynamic selection of a random access configuration may be conveyed via signaling that triggers a random access procedure, such as a PDCCH order for a random access procedure via DCI. The dynamic selection may enable a network entity to perform load balancing for RACH resources.

FIG. 6 depicts an example architecture 600 for dynamic selection of a random access configuration via signaling that triggers a random access (RA) procedure. In this example, a UE may obtain, from a network entity, a plurality of configurations 602 for RA communications, for example, via system information and/or radio resource control (RRC) signaling.

The plurality of configurations 602 may include a base configuration 604 and a set of configurations 606. The base configuration 604 may be or include a common configuration (e.g., RACH-ConfigCommon) that specifies cell specific random access parameter(s). In certain aspects, the random access parameters of the base configuration 604 may include, for example, the total number of preambles available for RA communications, a periodicity for a set of ROs, the total number of ROs in the set of ROs, the RAR window length (e.g., duration), a total number of ROs that can be frequency division multiplexed (FDM) in a time instance associated with a single RO (hereinafter “the FDM number”), etc.

The set of configurations 606 may include one or more configurations 608a-n (e.g., AdditionalRACH-Config) for RA communication. Each configuration of the set of configurations 606 may specify random access parameters associated with a combination of one or more features. The random access parameters may include any of the parameters discussed above for the base configuration. Specifically, the random access parameters may include a feature combination 610 and/or a RACH resource set 612, for example, as depicted for the nth configuration 608n.

In certain aspects, a set of ROs configured for a particular configuration (e.g., the first configuration 608a) of the set of configurations 606 may be arranged in the RACH resource set 612, which may include periodic time-frequency resource(s). In certain aspects, the RACH resource set 612 may be or include a set of preambles, a set of periodic ROs, a set of time domain resources (for the set of ROs), and/or a set of frequency domain resources (for the set of ROs) configured for RA communications. The RACH resource set 612 may be specified in a configuration (e.g., the first configuration 608a) via one or more parameters including a PRACH configuration index, which may indicate time domain positions for a periodic set of RO(s).

In certain aspects, the RACH resource sets configured for different configurations (e.g., the base configuration and/or any of the configurations in the set of configurations) may be different. For example, a RACH resource set configured for the first configuration 608a may be different from the RACH resource set configured for the nth configuration 608n and/or the base configuration 604.

In certain aspects, one or more look-up tables may define various sets of random access parameters, and a PRACH configuration index may be used to identify a specific set of parameter(s) in the look-up table(s). The PRACH configuration index may be associated with a particular row of parameter(s) in the look-up table(s). As an example, the PRACH configuration index may indicate certain parameters that define the time-domain position of RO(s) including, for example, the periodicity for the set of ROs based on the radio frame(s) and/or the subframe(s) that include RO(s) defined by the PRACH configuration index. In some cases, the PRACH configuration index may indicate that every radio frame includes RO(s). In certain cases, the PRACH configuration index may indicate that every other radio frame includes ROs. As an example, the PRACH configuration index may indicate that there is a single RO every 160 ms. As another example, the PRACH configuration index may indicate that there are 24 time multiplexed ROs every 20 ms. The FDM number may allow for multiple ROs to be multiplexed in the frequency domain per RO in the corresponding radio frames and subframes configured with time domain positions for RO(s). Accordingly, the periodicity and/or other parameter(s) for random access communications may be indicated with respect to a PRACH configuration index.

The feature combination 610 may identify the combination of one or more features associated with a particular configuration (e.g., the first configuration 608a) of the set of configurations 606. A combination of feature(s) may include, for example, a reduced capability (RedCap) feature (e.g., a type of IoT device), a small data transmission (SDT) feature, a network slice access stratum group (NSAG) feature, a MSG1 repetition feature, a MSG3 repetition feature, etc.

In certain aspects, when a UE has the feature(s) that match(es) a specific feature combination, the UE may apply the corresponding configuration associated with the feature combination for random access communications. For example, the first configuration 608a may be associated with a RedCap feature as indicated by the respective feature combination for the first configuration. A RedCap UE may obtain the set of configurations 606 and identify that the first configuration 608a is associated with the RedCap feature. When the RedCap UE is triggered to perform a RA procedure (e.g., the four-step procedure 500a of FIG. 5A), the RedCap UE may communicate via a RACH in an RO configured by the first configuration 608a associated with the RedCap feature.

In some cases, the RACH resource set 612 configured for a feature combination 610 may be unused or underused for RA communications designated for UE(s) having feature(s) that match one or more feature combinations specified for the set of configurations. In such cases, a network entity may determine to allow certain UE(s) (e.g., UE(s) without the feature(s) that match the feature combination 610) to use the RACH resource set 612 designated for the feature combination 610 for RA communications. In certain cases, a RACH resource set configured for the base configuration 604 may be unused or underused for RA communications. In such cases, a network entity may determine to allow certain UE(s) (e.g., UE(s) with feature(s) that match a feature combination) to use the RACH resource set configured for the base configuration 604. The network entity may notify a UE to perform RA communications via the RACH resource set 612 configured for a feature combination and/or the base configuration 604. Accordingly, the network entity may perform load balancing across the RACH resource set(s) configured for certain feature combinations 610 and/or the base configuration 604 to improve the usage of RACH resources (e.g., preamble(s), RO(s), and/or RACH usage) among one or more UEs with or without the features that match feature combination(s) 610 of the set of configurations 606.

Note that load balancing is merely an example to facilitate an understanding of when a network entity may trigger a UE to use a RACH resource set of a particular configuration (e.g., the base configuration 604 and/or the set of configurations 606) via signaling. Aspects of the present disclosure may apply to other suitable scenarios or criteria that may cause a network entity to trigger to a UE to use a RACH resource set of a particular configuration for RA communications, such as energy saving, radio conditions, interference mitigation, performance specifications (e.g., to ensure satisfaction of quality of service specification(s)), etc.

A UE may obtain, from a network entity, signaling 614 that triggers a RA procedure. The signaling 614 may be or include downlink control information (DCI). As an example, the signaling 614 may be or include a specific DCI format (e.g., DCI format 1_0) having a cyclic redundancy check (CRC) scrambled by a specific radio network temporary identifier (RNTI), such as a cell RNTI (C-RNTI). In certain aspects, the signaling may be or include a PDCCH order for RA communications. For example, when the CRC of the DCI format 1_0 is scrambled by C-RNTI and a particular field has a specific value (e.g., the “Frequency domain resource assignment” field is set to all ones), the DCI format 1_0 indicates to the UE to initiate (start) a RA procedure, such as the four-step RACH procedure 500a of FIG. 5A.

The signaling 614 may trigger a contention based RA procedure or a contention free RA procedure, for example, by excluding or including a preamble index in the signaling 614. With respect to contention free RA communications, the signaling 614 may include a contention free RA resource allocation 616, for example, indicating or including a random access preamble index, an SSB index to determine the RO for the PRACH transmission, the RO associated with the SSB indicated by the SSB index, etc.

In certain aspects, the signaling 614 may include one or more fields that identify a particular configuration among the base configuration 604 and/or the set of configurations 606 to use for RA communications. As an example, the signaling 614 may include a RACH configuration type field 618 and/or RACH configuration index field 620. The RACH configuration type field 618 may indicate to the UE whether to use the base configuration 604 or at least one configuration of the set of configurations 606 for RA communications. The RACH configuration type field 618 may be a one (single) bit indicator or bit flag. For example, when the RACH configuration type field 618 is set to a value of ‘1’, the RACH configuration type field 618 may indicate to use the base configuration 604 for RA communications; and when the RACH configuration type field 618 is set to a value of ‘0’, the RACH configuration type field 618 indicates to use at least one configuration of the set of configurations 606 for RA communications.

When the RACH configuration type field 618 indicates to use the set of configurations 606, the RACH configuration index field 620 may indicate to the UE to use a particular configuration of the set of configurations 606. The RACH configuration index field 620 may indicate an index value that points to the particular configuration of the set of configurations 606. For example, when the RACH configuration index field 620 is set to an index value of ‘0’, the RACH configuration index field 620 may indicate to use a first element in an ordered list associated with the set of configurations 606, where the first element in the ordered list may be the first configuration 608a. When the RACH configuration index field 620 is set to an index value of (N−1), the RACH configuration index field 620 may indicate to use the last element in the ordered list associated with the set of configurations 606, where the last element in the ordered list may be the nth configuration 608n.

In certain cases, the RACH configuration index field 620 may have a bit size that provides index values for the entire set of configurations 606. For example, when there are a total of sixteen configurations in the set of configurations 606 and the RACH configuration index field 620 has index values for the entire set of configurations, the RACH configuration index field 620 may have a bit size of four bits.

In some cases, the RACH configuration index field may have a bit size that provides index values only for a subset of the set of configurations. This may allow the signaling to use fewer bits for the dynamic selection of a particular configuration compared to when the entire set of configurations 606 is available for selection. As an example, when there are a total of sixteen configurations in the set of configurations 606 and the RACH configuration index field 620 has index values only for a subset of configurations, the RACH configuration index field 620 may have a bit size of 1, 2 or 3 bits. Accordingly, the RACH configuration index field 620 may point to an element of an ordered list for the subset of configurations, and the element in the ordered list may be an index value for a particular configuration of the set of configurations.

In certain aspects, the UE may obtain, from a network entity, an indication of which configuration(s) are in the subset of configurations. The UE may obtain an indication of an ordered list that defines the subset of configurations based on a sub-selection of index values for the set of configurations 606. The UE may obtain the sub-selection of the set of configurations via RRC signaling, MAC signaling, DCI, and/or system information.

In certain aspects, for a UE that lacks support for signaling with the selection of a particular configuration for RA communications, the UE may select the either the base configuration 604 or a configuration of the set of configurations 606. If the UE supports a feature combination associated with a configuration of the set of configurations 606, the UE may use that configuration for RA communications. If the UE lacks support for any of the feature combinations associated with the set of configurations 606, the UE may use the base configuration 604 for RA communications.

### Example Signaling of Dynamic Selection of a Random Access Configuration

FIG. 7 depicts a process flow 700 for signaling a dynamic selection of a random access configuration in a system between a network entity 702 and a user equipment (UE) 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

At 706, the UE 704 sends, to the network entity 702, capability information that indicates the UE 704 is capable of supporting the dynamic selection of a configuration for RA communications, such as described herein with respect to FIG. 6. The capability information may notify the network entity 702 that the dynamic selection can be signaled to the UE 704. In certain aspects, the capability information may be communicated via RRC signaling, MAC signaling, and/or UCI.

At 708, the UE 704 obtains, from the network entity 702 via first signaling, a plurality of configurations for random access communications, for example, as described herein with respect to FIG. 6. As an example, the configurations may include a base configuration (e.g., the base configuration 604) and a set of configurations (e.g., the set of configurations 606). In certain aspects, each of the configurations may indicate a set of parameters for random access communications. The set of configurations may define a set of feature-specific configurations for random access communications. The first signaling may be or include RRC signaling, MAC signaling, DCI, and/or system information (e.g., SIB1).

At 710, the UE 704 obtains, from the network entity 702, a sub-selection of the set of configurations, for example, as described herein with respect to FIG. 6. The sub-selection may define a subset of the set of configurations. In some cases, the network entity 702 may direct the UE to use a configuration in the subset for random access communications as described herein. In certain aspects, the sub-selection of the set of configurations may be communicated via RRC signaling, MAC signaling, DCI, and/or system information. In certain aspects, the sub-selection of the set of configurations may be via the first signaling at 708.

At 712, the UE 704 obtains, from the network entity 702, second signaling that indicates to start a random access procedure 714. For example, the network entity 702 may trigger the UE 704 to initiate the random access procedure 714 in order to re-synchronize the UE 704 (e.g., timing and/or frequency re-synchronization) for communications with the network entity 702. The second signaling may be an example of the signaling 614 of FIG. 6. For example, the second signaling may be or include DCI, such as a PDCCH order to initiate a random access procedure. The second signaling may also indicate a particular configuration to use for random access communications, for example, via a RACH configuration type field and/or a RACH configuration index field, as described herein with respect to FIG. 6. The dynamic selection of the random access configuration may allow the network entity 702 to direct random access traffic to the RACH resource set assigned to the configuration indicated in the signaling, for example, depending on the channel usage, radio conditions, and/or performance specifications for communications. In certain aspects, the second signaling may indicate or include a RACH preamble index for a content free random access (CFRA) procedure. For example, the UE 704 may obtain a dedicated random access preamble via the second signaling 714 for the random access procedure 714. In certain aspects, the first signaling may be different from the second signaling. For example, the UE 704 may obtain the first signaling and the second signaling via separate transmissions.

At 716, the UE 704 sends, to the network entity 702, a random access preamble (MSG1) in a RACH based at least in part on the indication of the particular configuration via the second signaling. For example, the particular configuration may configure certain RACH resource(s) (e.g., time-frequency resource(s)) for random access communications, and the UE 704 may send the random access preamble via such random RACH resource(s). The UE 704 may send the random access preamble in a random access occasion associated with the particular configuration indicated via the second signaling. In some cases (e.g., for a CFRA procedure), the UE 704 may send the dedicated random access preamble, which was assigned or indicated via the second signaling at 712.

At 718, the UE 704 obtains, from the network entity 702, a random access response (RAR) associated with the preamble transmission. In certain aspects, the UE 704 may obtain the RAR based at least in part on the configuration indicated via the second signaling. For example, the duration of the RAR window in which the RAR is communicated may be defined by the configuration. The RAR may also be referred to as MSG2. In certain aspects, the RAR may be communicated via a PDCCH and PDSCH transmission. For example, the UE 704 may obtain, from the network entity 702, a PDCCH transmission (e.g., DCI) scheduling the RAR on a PDSCH, and then the UE 704 may obtain, from the network entity 702, a PDSCH transmission carrying the RAR (e.g., a medium access control (MAC) protocol data unit (PDU) with a RAR payload associated with the preamble) in accordance with the scheduling indicated in the DCI. The RAR payload may indicate or include an UL grant for MSG3, for example, for a contention based random access (CBRA) procedure. For a CFRA procedure, the random access procedure 714 may be considered successful upon the UE's reception of the RAR, and contention resolution may not be performed (for example, communication of MSG3 and MSG4). In certain aspects, the RAR payload may indicate or include timing advance information, which may allow the UE 704 to re-synchronize with the network entity 702 for communications with the network entity 702.

At 720, the UE 704 sends, to the network entity 702, MSG3 via a PUSCH in accordance with the UL grant indicated in the RAR. As an example, MSG3 may indicate or include an RRC connection request, a tracking area update, and/or a scheduling request (for an UL transmission). The UE 704 may send MSG3 for a CBRA procedure.

At 722, the UE 704 obtains, from the network entity 702, a contention resolution message (MSG4) in response to MSG3. In some cases, the MSG4 may include an RRC connection setup message in response to the RRC connection request and/or an UL grant in response to the scheduling request, for example. The UE 704 may obtain MSG4 for a CBRA procedure.

At 724, the UE 704 communicates with the network entity 702 based on the RACH communications. As an example, the UE 704 may apply any configuration for the communication link between the UE 704 and the network entity 702 as indicated or included in MSG2 and/or MSG4 (e.g., the RRC connection setup message). As discussed above, MSG2 may indicate or include a timing advance command that allows the UE 704 to synchronize communications with the network entity 702, for example, in terms of a signal propagation delay between the UE 704 and the network entity 702. The RRC connection setup message may indicate or include various configurations, such as configuration(s) for control signaling (e.g., a PDCCH or a control resource set), PUSCH, PUCCH, PDSCH, transmit power control(s), channel state feedback reporting (e.g., CSI reporting), SRS, antenna configuration, and/or scheduling requests. In certain aspects, the configuration provided in the RRC connection setup message may facilitate the reception of subsequent configurations. In some cases, the UE 704 may transmit an UL signal in accordance with the UL grant provided in MSG4.

Note that certain aspects of the process flow 700 may be an example of a four-step RACH procedure to facilitate an understanding of the dynamic selection of a random access configuration. Aspects of the present disclosure may also apply to a two-step RACH procedure, for example, as described herein with respect to FIG. 5B.

### Example Operations for Dynamic Selection of a Random Access Configuration

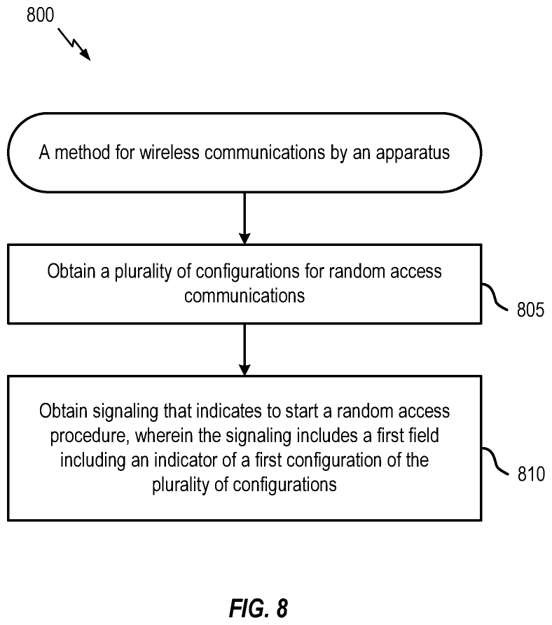

FIG. 8 shows a method 800 for wireless communications by an apparatus, such as UE 104 of FIGS. 1 and 3.

Method 800 begins at block 805 with obtaining a plurality of configurations (e.g., the plurality of configurations 602 of FIG. 6) for random access communications. In certain aspects, block 805 includes obtaining the plurality of configurations via radio resource control signaling and/or system information. For example, a UE may obtain, from a network entity, the plurality of configurations for random access communications as described herein with respect to FIGS. 6 and 7.

Method 800 then proceeds to block 810 with obtaining signaling (e.g., the signaling 614 of FIG. 6) that indicates to start a random access procedure, wherein the signaling includes a first field including an indicator of a first configuration of the plurality of configurations. In certain aspects, the signaling comprises downlink control information. For example, a UE may obtain, from a network entity, the signaling (e.g., a PDCCH order that triggers a RA procedure) as described herein with respect to FIGS. 6 and 7.

In certain aspects, the first configuration configures a first set of random access occasions. In certain aspects, the first configuration indicates that the first set of random access occasions is dedicated for at least one user equipment with one or more features for wireless communications.

In certain aspects, the first configuration is a common random access configuration that indicates at least one cell specific random-access parameter.

In certain aspects, method 800 further includes sending a message (e.g., a preamble message), for the random access procedure, in a first random access occasion associated with the first configuration.

In certain aspects, the plurality of configurations comprise the first configuration and a set of configurations; and the indicator of the first configuration (e.g., the RACH configuration type field 618 of FIG. 6) comprises one bit indicating the first configuration instead of the set of configurations.

In certain aspects, the plurality of configurations comprise a second configuration and a set of configurations comprising the first configuration; and the signaling includes a second field (e.g., the RACH configuration type field 618 of FIG. 6) including an indicator of the set of configurations.

In certain aspects, the plurality of configurations comprise a second configuration and a set of configurations comprising the first configuration; the method 800 further comprises obtaining an indication of a subset of the set of configurations, the subset comprising the first configuration; and the signaling includes a second field including an indicator of the subset.

In certain aspects, method 800 further includes sending an indication that the apparatus supports the first field in the signaling.

In certain aspects, method 800 further includes sending a message, for the random access procedure, in a random access occasion associated with the first configuration based on the apparatus supporting one or more features associated with the first configuration.

In certain aspects, method 800 further includes sending a message, for the random access procedure, in a random access occasion associated with a base configuration of the plurality of configurations based on the apparatus lacking support for one or more features associated with the first configuration.

In certain aspects, the plurality of configurations include the first configuration and a second configuration; the first configuration configures a first set of random access occasions including a first random access occasion; and the second configuration configures a second set of random access occasions.

In certain aspects, the first set of random access occasions are arranged in a first set of resources; the second set of random access occasions are arranged in a second set of resources; and the first set of resources is different from the second set of resources.

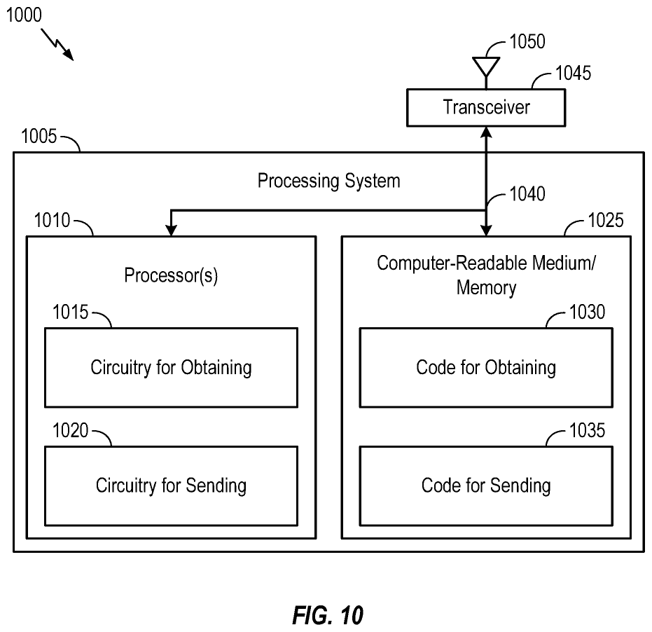

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

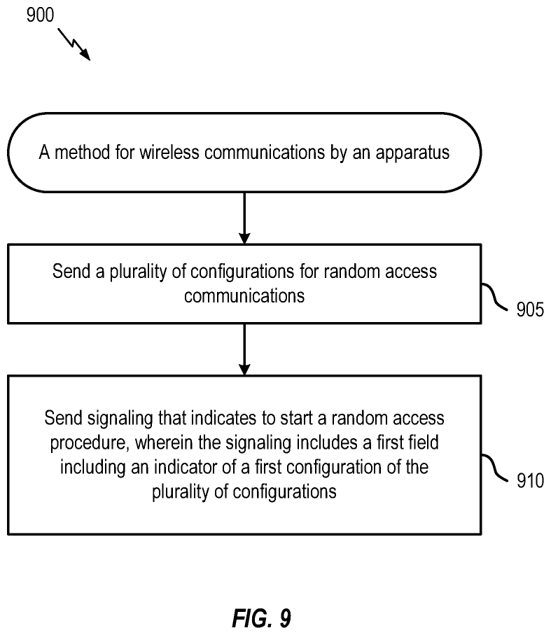

FIG. 9 shows a method 900 for wireless communications by an apparatus, such as BS 102 of FIGS. 1 and 3, or a disaggregated base station as discussed with respect to FIG. 2.

Method 900 begins at block 905 with sending a plurality of configurations (e.g., the plurality of configurations 602 of FIG. 6) for random access communications. In certain aspects, sending the plurality of configurations comprises sending the plurality of configurations via radio resource control signaling and/or system information. For example, a network entity may send, to a UE, the plurality of configurations for random access communications as described herein with respect to FIGS. 6 and 7.

Method 900 then proceeds to block 910 with sending signaling (e.g., the signaling 614 of FIG. 6) that indicates to start a random access procedure, wherein the signaling includes a first field including an indicator of a first configuration of the plurality of configurations. In certain aspects, the signaling comprises downlink control information. For example, a network entity may send, to a UE, the signaling (e.g., a PDCCH order that triggers a RA procedure) as described herein with respect to FIGS. 6 and 7.

In certain aspects, the first configuration configures a first set of random access occasions. In certain aspects, the first configuration indicates that the first set of random access occasions is dedicated for at least one user equipment with one or more features for wireless communications.

In certain aspects, the first configuration is a common random access configuration that indicates at least one cell specific random-access parameter.

In certain aspects, method 900 further includes obtaining a message (e.g., a preamble message), for the random access procedure, in a first random access occasion associated with the first configuration.

In certain aspects, the plurality of configurations comprise the first configuration and a set of configurations; and the indicator of the first configuration comprises one bit indicating the first configuration instead of the set of configurations.

In certain aspects, the plurality of configurations comprise a second configuration and a set of configurations comprising the first configuration; and the signaling includes a second field including an indicator of the set of configurations.

In certain aspects, the plurality of configurations comprise a second configuration and a set of configurations comprising the first configuration; the method 900 further comprises sending an indication of a subset of the set of configurations, the subset comprising the first configuration; and the signaling includes a second field including an indicator of the subset.

In certain aspects, method 900 further includes obtaining an indication that a user equipment supports the first field in the signaling.

In certain aspects, method 900 further includes obtaining, from a user equipment that supports one or more features associated with the first configuration, a message, for the random access procedure, in a random access occasion associated with the first configuration.

In certain aspects, method 900 further includes obtaining, from a user equipment that lacks support for one or more features associated with the first configuration, a message, for the random access procedure, in a random access occasion associated with a base configuration of the plurality of configurations.

In certain aspects, the plurality of configurations include the first configuration and a second configuration; the first configuration configures a first set of random access occasions including a first random access occasion; and the second configuration configures a second set of random access occasions.

In certain aspects, the first set of random access occasions are arranged in a first set of resources; the second set of random access occasions are arranged in a second set of resources; and the first set of resources is different from the second set of resources.

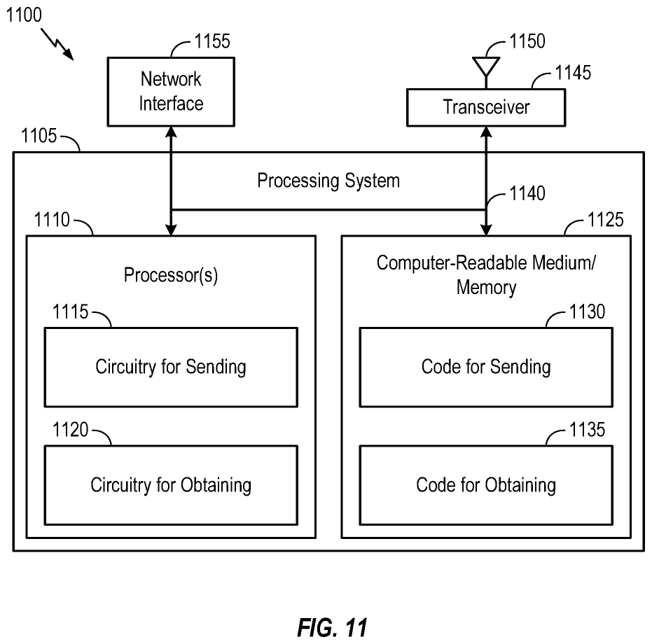

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1045 (e.g., a transmitter and/or a receiver). The transceiver 1045 is configured to transmit and receive signals for the communications device 1000 via an antenna 1050, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, enable and cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1025 stores code for obtaining 1030 and code for sending 1035. Processing of the code 1030 and 1035 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1025, including circuitry for obtaining 1015 and circuitry for sending 1020. Processing with circuitry 1015 and 1020 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1045 and/or antenna 1050 of the communications device 1000 in FIG. 10, and/or one or more processors 1010 of the communications device 1000 in FIG. 10. Means for communicating, receiving or obtaining may include the transceivers 354, antenna(s) 352, receive processor 358, AI processor 370, and/or controller/processor 380 of the UE 104 illustrated in FIG. 3, transceiver 1045 and/or antenna 1050 of the communications device 1000 in FIG. 10, and/or one or more processors 1010 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code) that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1125 stores code for sending 1130 and code for obtaining 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry for sending 1115 and circuitry for obtaining 1120. Processing with circuitry 1115 and 1120 may enable and cause the communications device 1100 to perform the method 900 described with respect to FIG. 9, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11.

### Example Clauses

Implementation examples are described in the following numbered clauses:

Clause 1: A method for wireless communications by an apparatus comprising: obtaining a plurality of configurations for random access communications; and obtaining signaling that indicates to start a random access procedure, wherein the signaling includes a first field including an indicator of a first configuration of the plurality of configurations.

Clause 2: The method of Clause 1, wherein the first configuration configures a first set of random access occasions.

Clause 3: The method of Clause 2, wherein the first configuration indicates that the first set of random access occasions is dedicated for at least one user equipment with one or more features for wireless communications.

Clause 4: The method of Clause 2, wherein the first configuration is a common random access configuration that indicates at least one cell specific random-access parameter.

Clause 5: The method of any one of Clauses 1-4, further comprising sending a message, for the random access procedure, in a first random access occasion associated with the first configuration.

Clause 6: The method of any one of Clauses 1-5, wherein: the plurality of configurations comprise the first configuration and a set of configurations; and the indicator of the first configuration comprises one bit indicating the first configuration instead of the set of configurations.

Clause 7: The method of any one of Clauses 1-6, wherein: the plurality of configurations comprise a second configuration and a set of configurations comprising the first configuration; and the signaling includes a second field including an indicator of the set of configurations.

Clause 8: The method of any one of Clauses 1-7, wherein: the plurality of configurations comprise a second configuration and a set of configurations comprising the first configuration; the method further comprises obtaining an indication of a subset of the set of configurations, the subset comprising the first configuration; and the signaling includes a second field including an indicator of the subset.

Clause 9: The method of any one of Clauses 1-8, further comprising sending an indication that the apparatus supports the first field in the signaling.

Clause 10: The method of any one of Clauses 1-9, wherein the signaling comprises downlink control information.

Clause 11: The method of any one of Clauses 1-10, wherein obtaining the plurality of configurations comprises obtaining the plurality of configurations via radio resource control signaling.

Clause 12: The method of any one of Clauses 1-11, further comprising sending a message, for the random access procedure, in a random access occasion associated with the first configuration based on the apparatus supporting one or more features associated with the first configuration.

Clause 13: The method of any one of Clauses 1-12, further comprising sending a message, for the random access procedure, in a random access occasion associated with a base configuration of the plurality of configurations based on the apparatus lacking support for one or more features associated with the first configuration.

Clause 14: The method of any one of Clauses 1-13, wherein: the plurality of configurations include the first configuration and a second configuration; the first configuration configures a first set of random access occasions including a first random access occasion; and the second configuration configures a second set of random access occasions.

Clause 15: The method of Clause 14, wherein: the first set of random access occasions are arranged in a first set of resources; the second set of random access occasions are arranged in a second set of resources; and the first set of resources is different from the second set of resources.

Clause 16: A method for wireless communications by an apparatus comprising: sending a plurality of configurations for random access communications; and sending signaling that indicates to start a random access procedure, wherein the signaling includes a first field including an indicator of a first configuration of the plurality of configurations.

Clause 17: The method of Clause 16, wherein the first configuration configures a first set of random access occasions.

Clause 18: The method of Clause 17, wherein the first configuration indicates that the first set of random access occasions is dedicated for at least one user equipment with one or more features for wireless communications.

Clause 19: The method of Clause 17, wherein the first configuration is a common random access configuration that indicates at least one cell specific random-access parameter.

Clause 20: The method of any one of Clauses 16-19, further comprising obtaining a message, for the random access procedure, in a first random access occasion associated with the first configuration.

Clause 21: The method of any one of Clauses 16-20, wherein: the plurality of configurations comprise the first configuration and a set of configurations; and the indicator of the first configuration comprises one bit indicating the first configuration instead of the set of configurations.

Clause 22: The method of any one of Clauses 16-21, wherein: the plurality of configurations comprise a second configuration and a set of configurations comprising the first configuration; and the signaling includes a second field including an indicator of the set of configurations.

Clause 23: The method of any one of Clauses 16-22, wherein: the plurality of configurations comprise a second configuration and a set of configurations comprising the first configuration; the method further comprises sending an indication of a subset of the set of configurations, the subset comprising the first configuration; and the signaling includes a second field including an indicator of the subset.

Clause 24: The method of any one of Clauses 16-23, further comprising obtaining an indication that a user equipment supports the first field in the signaling.

Clause 25: The method of any one of Clauses 16-24, wherein the signaling comprises downlink control information.

Clause 26: The method of any one of Clauses 16-25, wherein sending the plurality of configurations comprises sending the plurality of configurations via radio resource control signaling.

Clause 27: The method of any one of Clauses 16-26, further comprising obtaining, from a user equipment that supports one or more features associated with the first configuration, a message, for the random access procedure, in a random access occasion associated with the first configuration.

Clause 28: The method of any one of Clauses 16-27, further comprising obtaining, from a user equipment that lacks support for one or more features associated with the first configuration, a message, for the random access procedure, in a random access occasion associated with a base configuration of the plurality of configurations.

Clause 29: The method of any one of Clauses 16-28, wherein: the plurality of configurations include the first configuration and a second configuration; the first configuration configures a first set of random access occasions including a first random access occasion; and the second configuration configures a second set of random access occasions.

Clause 30: The method of Clause 29, wherein: the first set of random access occasions are arranged in a first set of resources; the second set of random access occasions are arranged in a second set of resources; and the first set of resources is different from the second set of resources.

Clause 31: One or more apparatuses, comprising: one or more memories comprising executable instructions; and one or more processors configured to execute the executable instructions and cause the one or more apparatuses to perform a method in accordance with any one of Clauses 1-30.

Clause 32: One or more apparatuses, comprising: one or more memories; and one or more processors, coupled to the one or more memories, configured to cause the one or more apparatuses to perform a method in accordance with any one of Clauses 1-30.

Clause 33: One or more apparatuses, comprising: one or more memories; and one or more processors, coupled to the one or more memories, configured to perform a method in accordance with any one of Clauses 1-30.

Clause 34: One or more apparatuses, comprising means for performing a method in accordance with any one of Clauses 1-30.

Clause 35: One or more non-transitory computer-readable media comprising executable instructions that, when executed by one or more processors of one or more apparatuses, cause the one or more apparatuses to perform a method in accordance with any one of Clauses 1-30.

Clause 36: One or more computer program products embodied on one or more computer-readable storage media comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a plurality of configurations for random access communications; and
obtain signaling that indicates to start a random access procedure, wherein the signaling includes a first field including an indicator of a first configuration of the plurality of configurations.

2. The apparatus of claim 1, wherein the one or more processors are configured to cause the apparatus to send a message, for the random access procedure, in a first random access occasion associated with the first configuration.

3. The apparatus of claim 1, wherein:
the plurality of configurations comprise the first configuration and a set of configurations; and
the indicator of the first configuration comprises one bit indicating the first configuration instead of the set of configurations.

4. The apparatus of claim 1, wherein:
the plurality of configurations comprise a second configuration and a set of configurations comprising the first configuration; and
the signaling includes a second field including an indicator of the set of configurations.

5. The apparatus of claim 1, wherein:
the plurality of configurations comprise a second configuration and a set of configurations comprising the first configuration;
the one or more processors are configured to cause the apparatus to obtain an indication of a subset of the set of configurations, the subset comprising the first configuration; and
the signaling includes a second field including an indicator of the subset.

6. The apparatus of claim 1, wherein the one or more processors are configured to cause the apparatus to send an indication that the apparatus supports the first field in the signaling.

7. The apparatus of claim 1, wherein the one or more processors are configured to cause the apparatus to send a message, for the random access procedure, in a random access occasion associated with the first configuration based on the apparatus supporting one or more features associated with the first configuration.

8. The apparatus of claim 1, wherein the one or more processors are configured to cause the apparatus to send a message, for the random access procedure, in a random access occasion associated with a base configuration of the plurality of configurations based on the apparatus lacking support for one or more features associated with the first configuration.

9. An apparatus configured for wireless communications, comprising:
one or more memories; and
one or more processors coupled to the one or more memories, the one or more processors being configured to cause the apparatus to:
send a plurality of configurations for random access communications; and
send signaling that indicates to start a random access procedure, wherein the signaling includes a first field including an indicator of a first configuration of the plurality of configurations.

10. The apparatus of claim 9, wherein the one or more processors are configured to cause the apparatus to obtain a message, for the random access procedure, in a first random access occasion associated with the first configuration.

11. The apparatus of claim 9, wherein:
the plurality of configurations comprise the first configuration and a set of configurations; and
the indicator of the first configuration comprises one bit indicating the first configuration instead of the set of configurations.

12. The apparatus of claim 9, wherein:
the plurality of configurations comprise a second configuration and a set of configurations comprising the first configuration; and
the signaling includes a second field including an indicator of the set of configurations.

13. The apparatus of claim 9, wherein:
the plurality of configurations comprise a second configuration and a set of configurations comprising the first configuration;
the one or more processors are configured to cause the apparatus to send an indication of a subset of the set of configurations, the subset comprising the first configuration; and
the signaling includes a second field including an indicator of the subset.

14. The apparatus of claim 9, wherein the one or more processors are configured to cause the apparatus to obtain an indication that a user equipment supports the first field in the signaling.

15. The apparatus of claim 9, wherein the one or more processors are configured to cause the apparatus to obtain, from a user equipment that supports one or more features associated with the first configuration, a message, for the random access procedure, in a random access occasion associated with the first configuration.

16. The apparatus of claim 9, wherein the one or more processors are configured to cause the apparatus to obtain, from a user equipment that lacks support for one or more features associated with the first configuration, a message, for the random access procedure, in a random access occasion associated with a base configuration of the plurality of configurations.

17. A method for wireless communications, comprising:
obtaining a plurality of configurations for random access communications; and
obtaining signaling that indicates to start a random access procedure, wherein the signaling includes a first field including an indicator of a first configuration of the plurality of configurations.

18. The method of claim 17, further comprising sending a message, for the random access procedure, in a first random access occasion associated with the first configuration.

19. The method of claim 17, wherein:
the plurality of configurations comprise the first configuration and a set of configurations; and
the indicator of the first configuration comprises one bit indicating the first configuration instead of the set of configurations.

20. The method of claim 17, wherein:
the plurality of configurations comprise a second configuration and a set of configurations comprising the first configuration; and
the signaling includes a second field including an indicator of the set of configurations.
